(19) United States
(12) Patent Application Publication
(10) Pub. No.: US 2024/0129519 A1
(43) Pub. Date: Apr. 18, 2024

(54) MOTION REFINEMENT WITH BILATERAL MATCHING FOR AFFINE MOTION COMPENSATION IN VIDEO CODING

(71) Applicant: BEIJING DAJIA INTERNET INFORMATION TECHNOLOGY CO., LTD., Beijing (CN)

(72) Inventors: Wei CHEN, San Diego, CA (US); Xiaoyu Xiu, San Diego, CA (US); Che-Wei KUO, Beijing (CN); Yi-Wen Chen, San Diego, CA (US); Hong-Jheng Jhu, Beijing (CN); Ning YAN, Beijing (CN); Xianglin Wang; Bing Yu, Beijing (CN)

(73) Assignee: BEIJING DAJIA INTERNET INFORMATION TECHNOLOGY CO., LTD., Beijing (CN)

(21) Appl. No.: 18/543,362

(22) Filed: Dec. 18, 2023

Related U.S. Application Data
(63) Continuation of application No. PCT/US2022/033803, filed on Jun. 16, 2022.
(60) Provisional application No. 63/211,682, filed on Jun. 17, 2021.

(51) Int. Cl. H04N 19/513; H04N 19/139; H04N 19/176

(52) U.S. Cl. CPC H04N 19/513; H04N 19/139; H04N 19/176

(57) ABSTRACT

Implementations of the disclosure provide systems and methods for motion refinement in a video. The method may include determining an initial motion vector for a video block of a video frame from the video. The method may include determining a matching target based on a weighted combination of a first reference block from a first reference frame in the video and a second reference block from a second reference frame in the video. The method may include performing a bilateral matching based motion refinement process at a block level to iteratively update the initial motion vector based on the matching target until a refined motion vector is obtained. The method may include refining a motion vector for each sub-block in the video block using the refined motion vector of the video block. Refining the motion vector at a sub-block level applies an affine motion model of the video block.

### CROSS-REFERENCE TO RELATED APPLICATION

This application is continuation of International Application No. PCT/US2022/033803, filed on Jun. 16, 2022, which is based upon and claims priority to U.S. Provisional Application No. 63/211,682 filed Jun. 17, 2021, both of which are incorporated herein by reference in their entireties.

### TECHNICAL FIELD

This application is related to video coding and compression. More specifically, this application relates to video processing systems and methods for motion refinement in a video.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

Implementations of the present disclosure provide a video coding method for motion refinement in a video. The video coding method may include determining, by one or more processors, an initial motion vector for a video block of a video frame from the video. The video coding method may also include determining, by the one or more processors, a matching target based on a weighted combination of a first reference block from a first reference frame in the video and a second reference block from a second reference frame in the video. The video coding method may further include performing, by the one or more processors, a bilateral matching based motion refinement process at a block level to iteratively update the initial motion vector based on the matching target until a refined motion vector is obtained for the video block. The video coding method may additionally include refining, by the one or more processors, a motion vector for each sub-block in the video block using the refined motion vector of the video block as a starting point for the motion vector for the sub-block. Refining the motion vector at a sub-block level applies an affine motion model of the video block.

Implementations of the present disclosure also provide a video coding apparatus for motion refinement in a video. The video coding apparatus may include a memory and one or more processors. The memory may be configured to store at least one video frame of a video. The video frame includes at least one video block. The one or more processors may be configured to determine an initial motion vector for the video block. The one or more processors may be configured to determine a matching target based on a weighted combination of a first reference block from a first reference frame in the video and a second reference block from a second reference frame in the video. The one or more processors may be further configured to perform a bilateral matching based motion refinement process at a block level to iteratively update the initial motion vector based on the matching target until a refined motion vector is obtained for the video block. The one or more processors may be additionally configured to refine a motion vector for each sub-block in the video block using the refined motion vector of the video block as a starting point for the motion vector for the sub-block. The one or more processors may apply an affine motion model of the video block to refine the motion vector at a sub-block level.

Implementations of the present disclosure also provide a non-transitory computer-readable storage medium storing a bitstream to be coded by a video coding method for motion refinement in a video. The video coding method may include determining an initial motion vector for a video block of a video frame from a video based on a merge list of the video block. The video coding method may further include determining a matching target based on a weighted combination of a first reference block from a first reference frame in the video and a second reference block from a second reference frame in the video. The video coding method may further include performing a bilateral matching based motion refinement process at a block level to iteratively update the initial motion vector based on the matching target until a refined motion vector is obtained for the video block. The video coding method may also include refining a motion vector for each sub-block in the video block using the refined motion vector of the video block as a starting point for the motion vector for the sub-block. Refining the motion vector at a sub-block level applies an affine motion model of the video block. The video coding method may additionally include generating the bitstream including a merge index for identifying the initial motion vector from the merge list, a first reference index for identifying the first reference frame, and a second reference index for identifying the second reference frame.

It is to be understood that both the foregoing general description and the following detailed description are examples only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2 is a block diagram illustrating an exemplary video encoder in accordance with some implementations of the present disclosure.

FIG. 3 is a block diagram illustrating an exemplary video decoder in accordance with some implementations of the present disclosure.

FIGS. 4A through 4E are graphical representations illustrating how a frame is recursively partitioned into multiple video blocks of different sizes and shapes in accordance with some implementations of the present disclosure.

FIG. 5A illustrates an exemplary 4-parameter affine motion model in accordance with some implementations of the present disclosure.

FIG. 5B illustrates an exemplary 6-parameter affine motion model in accordance with some implementations of the present disclosure.

FIG. 6 is a graphical representation illustrating exemplary bilateral matching in accordance with some implementations of the present disclosure.

FIG. 7 is a block diagram illustrating an exemplary process for bilateral matching based motion refinement for affine motion compensation in accordance with some implementations of the present disclosure.

FIG. 8 is a graphical representation illustrating exemplary calculation of a matching target in accordance with some implementations of the present disclosure.

FIG. 9 is a flow chart of an exemplary method for motion refinement in a video in accordance with some implementations of the present disclosure.

FIG. 10 is a flow chart of another exemplary method for motion refinement in a video in accordance with some implementations of the present disclosure.

FIG. 11 is a block diagram illustrating a computing environment coupled with a user interface in accordance with some implementations of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

In the current VVC standard and the third-generation audio video coding standard (AVS3), motion information of a current coding block at a video decoder is either inherited from a spatial or temporal neighboring block in the form of merge mode candidate index or derived based on explicit signaling of the estimated motion information sent from a video encoder. However, the explicit signaling of the estimated motion information may incur signaling overhead. On the other hand, application of merge mode motion vectors (MVs) can save signaling overhead, but the merge mode MVs may be of less accuracy since they are only copied from neighboring blocks.

Consistent with the present disclosure, a video processing system and method are disclosed herein to improve accuracy of motion vector estimation for affine motion prediction mode used in both the VVC and AVS3 standards. Since bilateral matching is a motion refinement method that does not require extra signaling, the system and method disclosed herein can apply bilateral matching to improve the accuracy of the motion information for affine merge mode and achieve higher coding efficiency. For example, various video coding techniques (including merge mode, affine mode, bilateral matching, etc.) can be combined and applied in the system and method disclosed herein to enhance the motion information at both a block level and a sub-block level.

Consistent with the present disclosure, the system and method disclosed herein can improve the affine merge mode by applying bilateral matching to refine motion information of a video block. Specifically, the system and method disclosed herein may derive an initial motion vector for the video block using the merge mode, determine a matching target for the video block, and perform a bilateral matching based motion refinement process at the video block level to iteratively update the initial motion vector until a refined motion vector is obtained for the video block. For example, when bilateral matching is applied, an initial motion vector is first derived for the video block as a starting point (e.g., a starting motion vector), and then an iterative update around the starting motion vector is performed to obtain a refined motion vector with a minimum matching cost. The refined motion vector with the minimum matching cost can be selected as the motion vector for the video block at the video block level. Subsequently, the refined motion vector at the video block level can be used as a new starting point to further refine the motion information of sub-blocks at a sub-block level in an affine mode.

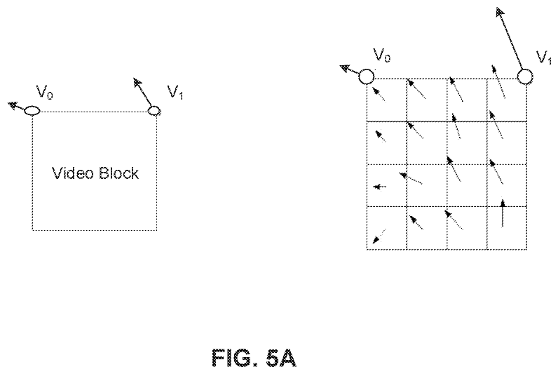

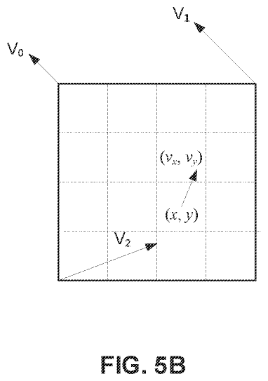

Consistent with the present disclosure, the affine merge mode described herein may be referred to as a combination of a merge mode and an affine mode. The merge mode can be an inter coding mode used in video compression. With the merge mode, a motion vector of a neighboring video block is inherited for a current video block being encoded or decoded. For example, the merge mode causes the current video block to inherit a motion vector of a predetermined neighbor. In another example, an index value may be used to identify a specific neighbor from which the current video block inherits its motion vector. The neighbor can be a spatially adjacent video block (e.g., a top, top right, left, or left bottom video block) from the same video frame, or a co-located video block from a temporally adjacent video frame. Consistent with the present disclosure, the merge mode can be used to determine an initial motion vector for the current video block (e.g., as a starting point for the motion refinement). With respect to the affine mode, an affine motion model can be applied for inter prediction. The affine mode is described below in more detail with reference to FIGS. 5A-5B.

Consistent with the present disclosure, an affine mode design in the VVC standard can be used as an exemplary implementation of affine motion prediction mode to facilitate the description of the present disclosure. It is contemplated that the system and method disclosed herein can also apply a different design of affine motion prediction mode or other coding tools with the same or similar design spirit.

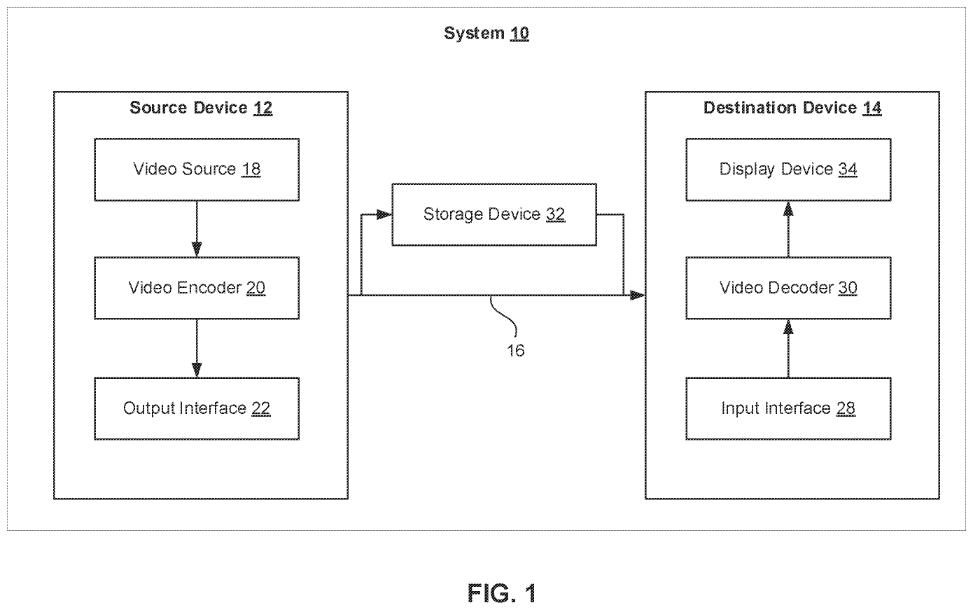

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may include any of a wide variety of electronic devices, including desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may include any type of communication medium or device capable of forwarding the encoded video data from the source device 12 to the destination device 14. In one example, the link 16 may include a communication medium to enable the source device 12 to transmit the encoded video data directly to the destination device 14 in real time. The encoded video data may be modulated according to a communication standard, such as a wireless communication protocol, and transmitted to the destination device 14. The communication medium may include any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may store the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or any combination thereof that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20, and the output interface 22. The video source 18 may include a source such as a video capturing device, e.g., a video camera, a video archive containing previously captured video, a video feeding interface to receive video data from a video content provider, and/or a computer graphics system for generating computer graphics data as the source video, or a combination of such sources. As one example, if the video source 18 is a video camera of a security surveillance system, the source device 12 and the destination device 14 may include camera phones or video phones. However, the implementations described in the present disclosure may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data for a user, and may include any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present disclosure is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

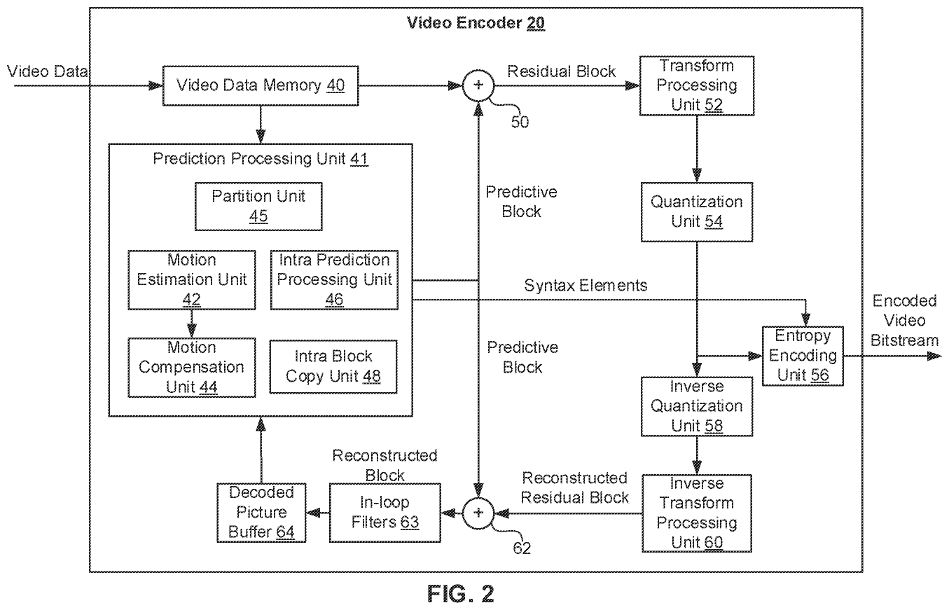

FIG. 2 is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove block artifacts from reconstructed video data. Another in-loop filter, such as an SAO filter and/or Adaptive in-Loop Filter (ALF), may also be used in addition to the deblocking filter to filter an output of the summer 62. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning, Triple-Tree (TT) partitioning or any combination thereof. It should be noted that the term “block” or “video block” as used herein may be a portion, in particular a rectangular (square or non-square) portion, of a frame or a picture. With reference to, for example, HEVC and VVC, the block or video block may be or correspond to a Coding Tree Unit (CTU), a CU, a Prediction Unit (PU), or a Transform Unit (TU), and/or may be or correspond to a corresponding block, e.g., a Coding Tree Block (CTB), a Coding Block (CB), a Prediction Block (PB), or a Transform Block (TB). Alternatively or additionally, the block or video block may be or correspond to a sub-block of a CTB, a CB, a PB, a TB, etc.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block (e.g., a predictive block) to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference frame, according to a predetermined pattern within a sequence of video frames. Motion estimation, performed by the motion estimation unit 42, may be a process of generating motion vectors, which may estimate motion for video blocks. A motion vector, for example, may indicate the displacement of a video block within a current video frame or picture relative to a predictive block within a reference frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vectors.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual block of pixel difference values by subtracting pixel values of the predictive block provided by the motion compensation unit 44 from the pixel values of the current video block being coded. The pixel difference values forming the residual block may include luma or chroma difference components or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. It is noted that the motion estimation unit 42 and the motion compensation unit 44 may be integrated together, which are illustrated separately for conceptual purposes in FIG. 2.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or from a different frame according to inter prediction, the video encoder 20 may form a residual block by subtracting pixel values of the predictive block from the pixel values of the current video block being coded, forming pixel difference values. The pixel difference values forming the residual block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. For example, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in a bitstream.

After the prediction processing unit 41 determines the predictive block for the current video block via either inter prediction or intra prediction, the summer 50 forms a residual block by subtracting the predictive block from the current video block. The residual video data in the residual block may be included in one or more TVs and is provided to the transform processing unit 52. The transform processing unit 52 transforms the residual video data into transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 may use an entropy encoding technique to encode the quantized transform coefficients into a video bitstream, e.g., using Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding, or another entropy encoding methodology or technique. The encoded bitstream may then be transmitted to the video decoder 30 as shown in FIG. 1 or archived in the storage device 32 as shown in FIG. 1 for later transmission to or retrieval by the video decoder 30. The entropy encoding unit 56 may also use an entropy encoding technique to encode the motion vectors and the other syntax elements for the current video frame being coded.

The inverse quantization unit 58 and the inverse transform processing unit 60 apply inverse quantization and inverse transformation, respectively, to reconstruct the residual block in the pixel domain for generating a reference block for prediction of other video blocks. A reconstructed residual block may be generated thereof. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42, and the motion compensation unit 44 as a predictive block to inter predict another video block in a subsequent video frame.

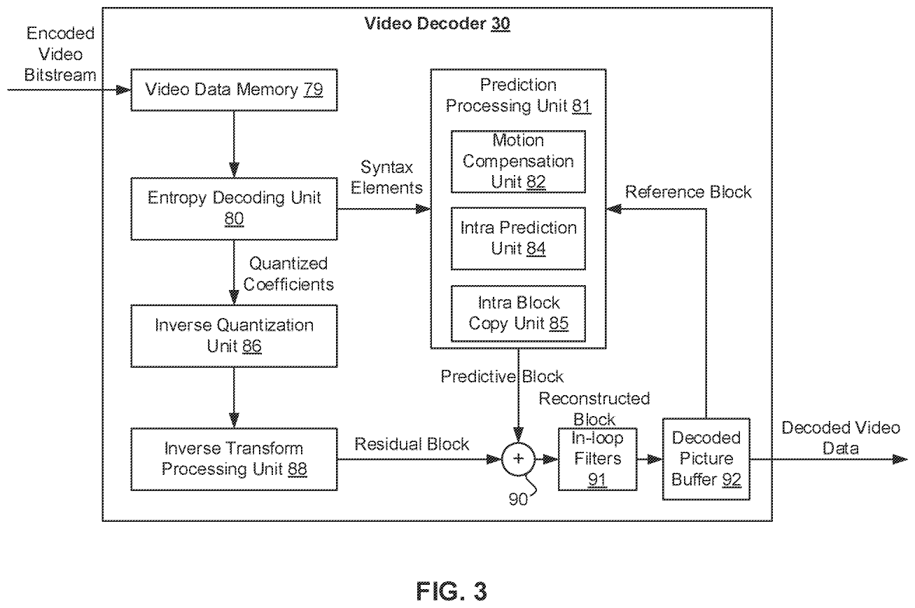

FIG. 3 is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Butler (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 may use an entropy decoding technique to decode the bitstream to obtain quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (e.g., I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, e.g., List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block processed by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inversely quantizes the quantized transform coefficients provided in the bitstream and decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs a decoded video block for the current video block by summing the residual block from the inverse transform processing unit 88 and a corresponding predictive block generated by the motion compensation unit 82 and the intra BC unit 85. The decoded video block may also be referred to as a reconstructed block for the current video block. An in-loop filter 91 such as a deblocking filter, SAO filter, and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process (e.g., including a video encoding process and a video decoding process), a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

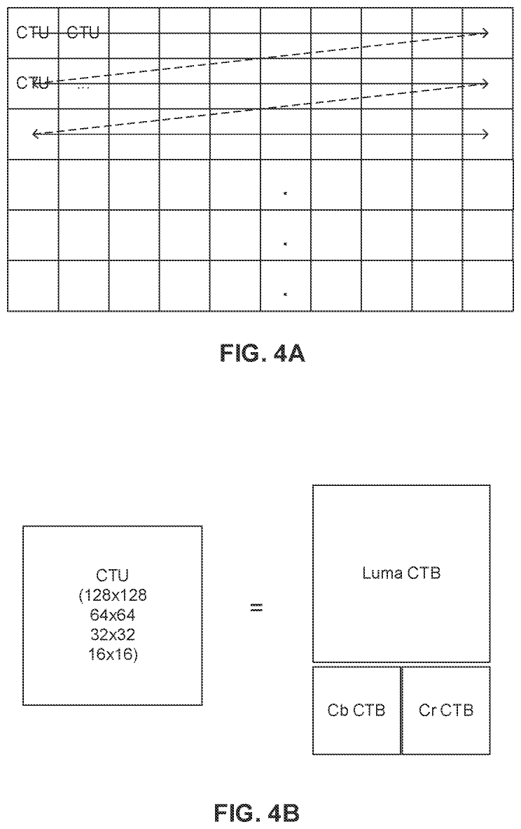

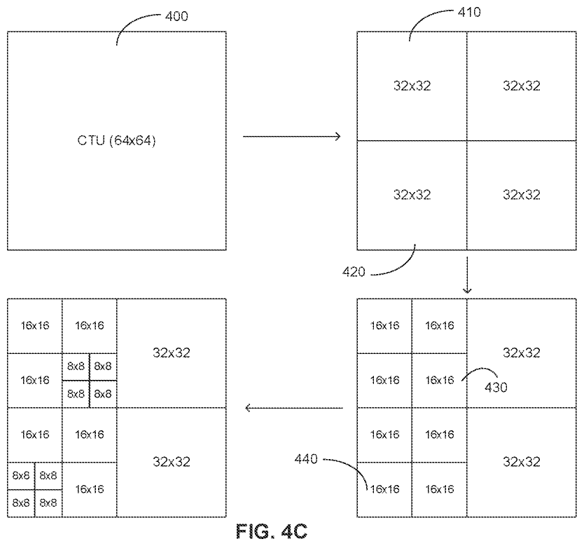

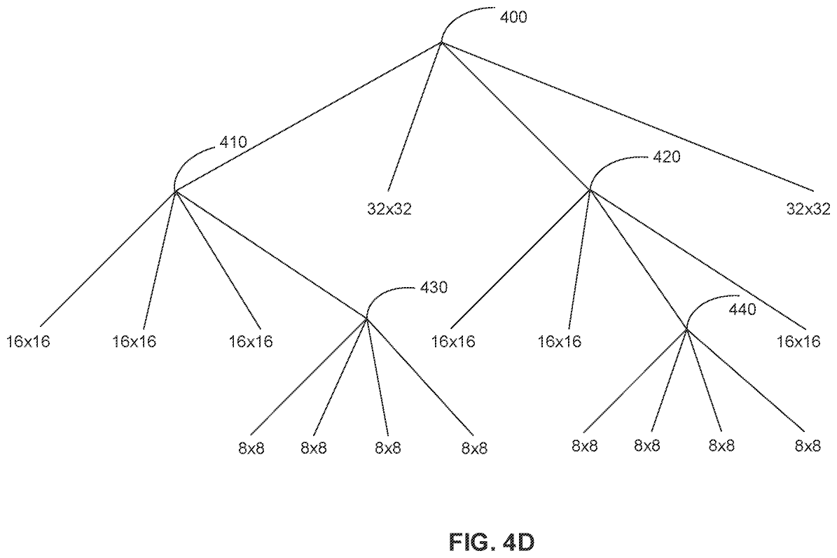

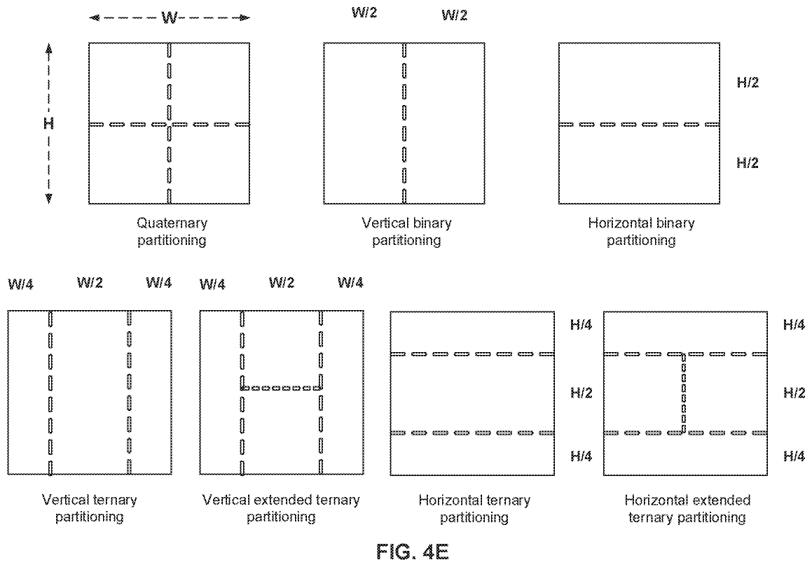

As shown in FIG. 4A, the video encoder 20 (or more specifically the partition unit 45) generates an encoded representation of a frame by first partitioning the frame into a set of CTUs. A video frame may include an integer number of CTUs arranged consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that a CTU in the present disclosure is not necessarily limited to a particular size. As shown in FIG. 4B, each CTU may include one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may include a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may include a CB of luma samples and two corresponding coding blocks of chroma samples of a frame of the same size, and syntax elements used to code the samples of the coding blocks. In monochrome pictures or pictures having three separate colour planes, a CU may include a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are multiple possible partitioning types of a coding block having a width W and a height H, i.e., quaternary partitioning, vertical binary partitioning, horizontal binary partitioning, vertical ternary partitioning, vertical extended ternary partitioning, horizontal ternary partitioning, and horizontal extended ternary partitioning.

In some implementations, the video encoder 20 may further partition a coding block of a CU into one or more M×N PBs. A PB may include a rectangular (square or non-square) block of samples on which the same prediction, inter or intra, is applied. A PU of a CU may include a PB of luma samples, two corresponding PBs of chroma samples, and syntax elements used to predict the PBs. In monochrome pictures or pictures having three separate color planes, a PU may include a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block, and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block may include a rectangular (square or non-square) block of samples on which the same transform is applied. A TU of a CU may include a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may include a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block, or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may apply an entropy encoding technique to encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that form a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that intra block copy (IBC) could be regarded as either intra-frame prediction or a third mode. Between the two modes, inter-frame prediction contributes more to the coding efficiency than intra-frame prediction because of the use of motion vectors for predicting a current video block from a reference video block.

But with the ever-improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding an actual motion vector of the current CU into the video bitstream (e.g., the actual motion vector being determined by the motion estimation unit 42 as described above in connection with FIG. 2), the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream, and the amount of data used for representing motion information in the video bitstream can be significantly decreased.

Like the process of choosing a predictive block in a reference frame during inter-frame prediction of a code block, a set of rules can be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30, and an index of the selected motion vector predictor within the motion vector candidate list is sufficient for the video encoder 20 and the video decoder 30 to use the same motion vector predictor within the motion vector candidate list for encoding and decoding the current CU. Thus, only the index of the selected motion vector predictor needs to be sent from the video encoder 20 to the video decoder 30.

A brief discussion with respect to affine mode is provided herein with reference to FIGS. 5A-5B. In HEVC, only a translation motion model is applied for motion compensated prediction. While in the real world, there can be various kinds of motion, e.g., zoom in, zoom out, rotation, perspective motions, and other irregular motions, in the VVC and AVS3 standards, affine motion compensated prediction can be applied by signaling a flag for each inter coding block to indicate whether a translation motion model or an affine motion model is applied for inter prediction. In some implementations, one of the two affine modes (e.g., a 4-parameter affine motion model as shown in FIG. 5A or a 6-parameter affine motion model as shown in FIG. 5B) can be selected and applied to an affine-coded video block.

The 4-parameter affine motion model shown in FIG. 5A includes the following affine parameters: two parameters for translation movement in horizontal and vertical directions respectively, one parameter for zoom motion, and one parameter for rotational motion for both horizontal and vertical directions. In this model, the horizontal zoom parameter can be equal to the vertical zoom parameter, and the horizontal rotation parameter can be equal to the vertical rotation parameter. To achieve a better accommodation of the motion vectors and affine parameters, the affine parameters of this model can be coded with two motion vectors (referred to as control point motion vectors (CPMVs)) located at two control points (e.g., the top-left corner and top-right corner) of a current video block. As shown in FIG. 5A, an affine motion field of the video block (e.g., motion vectors of the video block) can be described by two CPMVs V₀ and V₁. Based on the control point motion, a motion field of an affine coded sub-block with a position (x, y) within the video block can be derived using the following expression (1):

$$\begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix} \qquad ( 1 )$$

In the above expression (1), vₓ and v_{y} denote an x-component and a y-component of a motion vector of the affine coded sub-block at the position (x, y), respectively. w denotes a width of the video block. v₀ₓ and v_{0y} denote an v-component and a y-component of the CPMV V₀, respectively. v₁ₓ and v_{1y} denote an x-component and ay-component of the CPMV V₁, respectively.

The 6-parameter affine motion model as shown in FIG. 5B includes the following affine parameters: two parameters for translation movement in the horizontal and vertical directions respectively, two parameters for zoom motion and rotation motion respectively in the horizontal direction, and another two parameters for zoom motion and rotation motion respectively in the vertical direction. The 6-parameter affine motion model can be coded with three CPMVs at three control points. As shown in FIG. 5B, the three control points of the 6-parameter affine video block are located at the top-left, top-right, and bottom left corners of the video block, and associated with CPMVs V₀, V₁, and V₂, respectively. The motion at the top-left control point is related to the translation motion, the motion at the top-right control point is related to rotation and zoom motion in the horizontal direction, and the motion at the bottom-left control point is related to rotation and zoom motion in the vertical direction. Compared to the 4-parameter affine motion model, the rotation and zoom motion in the horizontal direction of the 6-parameter affine motion model may not be the same as the rotation and zoom motion in the vertical direction. A motion vector (vₓ, v_{y}) of each sub-block located at a position (x, y) of the video block can be derived using the three CPMVs at the three control points by:

$$\begin{matrix}{v}_{x} = {v}_{0 x} + ( {v}_{1 x} - {v}_{0 x} ) * \frac{x}{w} + ( {v}_{2 x} - {v}_{0 x} ) * \frac{y}{h} \\ {v}_{y} = {v}_{0 y} + ( {v}_{1 y} - {v}_{0 y} ) * \frac{x}{w} + ( {v}_{2 y} - {v}_{0 y} ) * \frac{y}{h}\end{matrix} \qquad ( 2 )$$

In the above expression (2), vₓ and v_{y} denote an x-component and a y-component of the motion vector of the affine coded sub-block at the position (x, y), respectively. w and h denote a width and a height of the video block, respectively. v₀ₓ and v_{0y} denote an x-component and a y-component of the CPMV V₀, respectively. v₁ₓ and v_{1y} denote an x-component and a y-component of the CPMV V₁, respectively. v₂ₓ and v_{2y} denote an x-component and a y-component of the CPMV V₂, respectively.

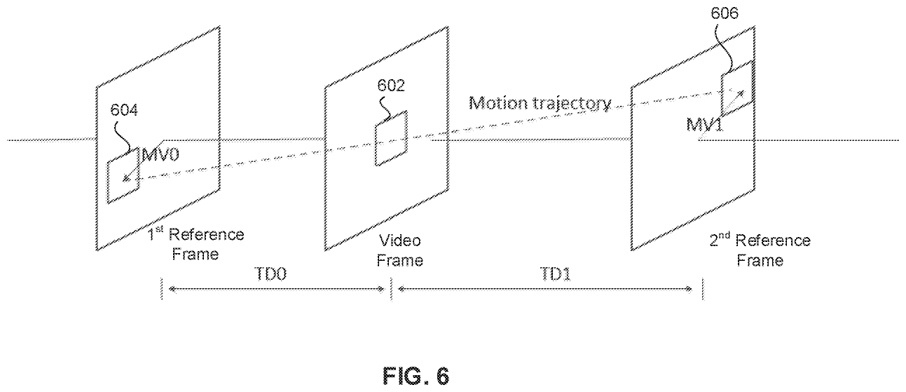

FIG. 6 is a graphical representation illustrating an exemplary bilateral matching in accordance with some implementations of the present disclosure. In the domain of video coding, bilateral matching is a technique with which motion information of a currently coded video block is not signaled to the decoder side but derived at the decoder side. When bilateral matching is used for the motion derivation process, an initial motion vector can be firstly derived for the whole video block. Specifically, a merge list of the video block can be checked, and a candidate motion vector from the merge list which leads to a minimum matching cost among all the candidate motion vectors in the merge list can be selected as a starting point. Then, a local search around the starting point within a search range can be performed, and a motion vector which results in a minimum matching cost within the search range can be taken as the motion vector for the whole video block. Subsequently, the motion information can be further refined at a sub-block level using the motion vector for the whole video block as a new starting point. For example, several CPMVs can be derived for the whole video block, and then, motion vectors at the sub-block level can be derived by applying the CPMVs at the video block level based on the above expression (1) or (2).

As shown in the FIG. 6, bilateral matching can be used to derive motion information of a video block 602 in a video frame by finding two best matched reference blocks 604, 606 along a motion trajectory of the video block from two different reference frames. Under the assumption of a continuous motion trajectory, motion vectors MV0 and MV1 pointing to the two reference blocks 604, 606 may be proportional to temporal distances of the reference frames relative to the video frame (e.g., TD0 and TD1), respectively. As a special case, when the video frame is temporally between the two reference frames and the temporal distances from the video frame to the two reference frames are the same (e.g., TD0=TD1), the motion vectors derived from the bilateral matching become mirror based bi-directional motion vectors.

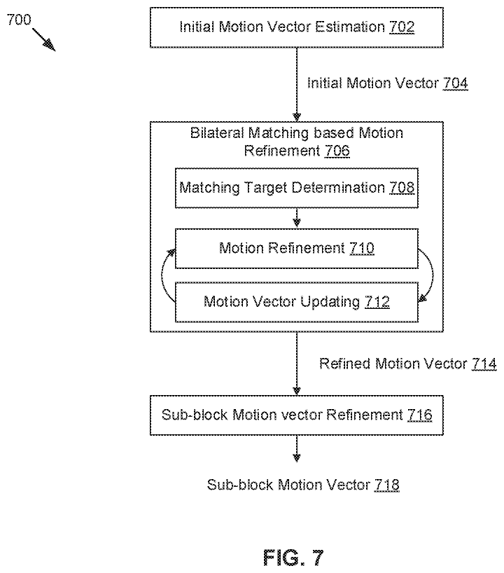

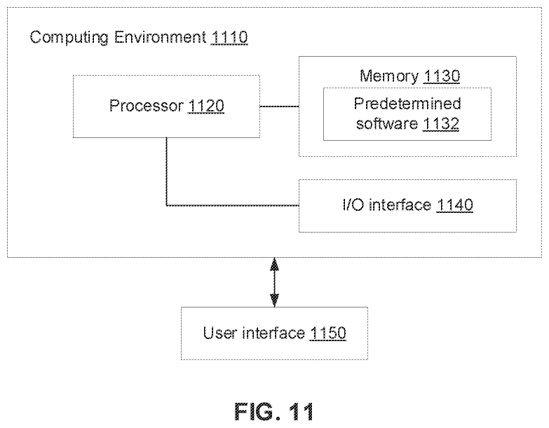

FIG. 7 is a block diagram illustrating an exemplary process 700 for motion refinement with bilateral matching for affine motion compensation in accordance with some implementations of the present disclosure. In some implementations, process 700 can be performed by prediction processing unit 41 (e.g., including motion estimation unit 42, motion compensation unit 44, etc.) of video encoder 20, or prediction processing unit 81 (e.g., including motion compensation unit 82) of video decoder 30. In some implementations, process 700 may be performed by a video processor (e.g., a processor 1120 as shown in FIG. 11) at an encoder side or a decoder side. For illustration purpose only, the following description of process 700 is provided with respect to the video processor.

To encode or decode a video block from a video frame of a video, the video processor may perform an initial motion vector estimation 702 to generate an initial motion vector 704 for the video block. For example, the video processor may determine initial motion vector 704 for the video block based on a merge list of the video block. Specifically, the merge list of the video block can be checked, and a candidate motion vector from the merge list which leads to a minimum matching cost among all the candidate motion vectors in the merge list can be selected as initial motion vector 704.

The video processor may perform a bilateral matching based motion refinement process 706 at the video block level to iteratively update initial motion vector 704 until a refined motion vector 714 is obtained for the video block. Initial motion vector 704 can be used as a starting point (e.g., a starting motion vector) for the bilateral matching based motion refinement process 706. When an iterative update around the starting motion vector is performed, a matching cost (e.g., a bilateral matching cost) between a current prediction of the video block and a matching target can be iteratively calculated to guide the progressive update of the starting motion vector for the video block. In some implementations, the matching cost between the current prediction of the video block and the matching target can be calculated based on a matching cost function. The matching cost function can be a Sum of Absolute Difference (SAD), a mean removed SAD (MRSAD), a Sum of Square Difference (SSD), or any other suitable difference metric between the current prediction of the video block and the matching target.

If the video block is coded in the affine mode, initial motion vector 704 may include one or more initial CPMVs at one or more control points of the video block. Refined motion vector 714 may include one or more refined CPMVs at the one or more control points.

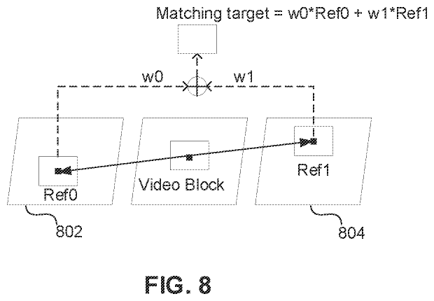

To begin with the bilateral matching based motion refinement process 706, the video processor may perform a matching target determination operation 708 to determine a matching target for the iterative update of the motion information. For example, with reference to FIG. 8, the video processor may determine, based on initial motion vector 704, a first reference block Ref0 and a second reference block Ref1 from a first reference frame 802 and a second reference frame 804 of the video, respectively. The video processor may determine a matching target based on a weighted combination of the first reference block Ref0 and the second reference block Ref1. For example, the matching target may be equal to a weighted sum of Ref0 and Ref1 (e.g., matching target=w0*Ref0+w1*Ref1, where w0 and w1 denote weights of Ref0 and Ref1, respectively).

In some implementations, the inter coding modes disclosed herein (e.g., the merge mode) may be bi-predictive, indicating that two different lists of reference frames (e.g., List 0 and List 1) are used to identify two predictions of the video block. For example, List 0 may include a list of reference frames preceding the video block, and List 1 may include a list of reference frames subsequent to the video block. Ref0 can be a List 0 prediction from first reference frame 802 based on initial motion vector 704. Ref1 can be a List 1 prediction from second reference frame 804 based on initial motion vector 704. The matching target can be a weighted sum of the List 0 and List 1 predictions derived based on initial motion vector 704.

Alternatively, the matching target can be a weighted combination of the List 0 and List 1 predictions plus corresponding prediction residuals associated with the List 0 and List 1 predictions. In this case, the matching target can be a weighted combination of a List 0 reconstruction and a List 1 reconstruction. For example, the List 0 reconstruction=the List 0 prediction+a List 0 prediction residual, the List 1 reconstruction=the List 1 prediction+a List 1 prediction residual, and the matching target=w0*the List 0 reconstruction+w1*the List 1 reconstruction.

In some implementations, the weights w0 and w1 may reuse the same values derived at the encoder side for normal weighted bi-predictions (e.g., bi-prediction with CU-level weights). Alternatively, the weights w0 and w1 may have predetermined values. For example, w0=w1=½. In another example, w0=1 and w1=0, or w0=0 and w1=1. When one of the weights w0 and w1 is 0, the bilateral matching becomes a uni-directional motion vector refinement instead of a bi-directional motion vector refinement.

In some implementations, the weights w0 and w1 may have values with different signs. For example, w0=1, w1=−1. In this case, a bi-prediction difference can be used for calculating a matching cost. Specifically, the bi-prediction difference generated before the starting motion vector is updated and after the starting motion vector is updated is calculated to determine the matching cost.

Referring back to the bilateral matching based motion refinement process 706 of FIG. 7, the video processor may iteratively perform a motion refinement operation 710 and a motion vector updating operation 712 until refined motion vector 714 is generated for the video block. For example, the video processor may use initial motion vector 704 to initialize an intermediate motion vector for the video block, and may determine a motion refinement for the intermediate motion vector based on the matching target. The video processor may update the intermediate motion vector based on the motion refinement. The intermediate motion vector may represent the motion vector of the video block while performing the bilateral matching based motion refinement process 706. Then, the video processor may determine whether a predetermined iteration-stop condition is satisfied. If the predetermined iteration-stop condition is satisfied, the video processor may determine the intermediate motion vector to be refined motion vector 714. On the other hand, if the predetermined iteration-stop condition is not satisfied, the video processor may continue to iteratively determine the motion refinement for the intermediate motion vector and update the intermediate motion vector based on the motion refinement until the predetermined iteration-stop condition is satisfied.

In some implementations, the predetermined iteration-stop condition can be satisfied if the intermediate motion vector converges. Alternatively, the predetermined iteration-stop condition can be satisfied if a total number of iterations meets a predetermined threshold (e.g., the total number of iterations reaches a predetermined upper limit).

In some implementations, the motion refinement for the intermediate motion vector can be determined through a calculation based derivation, a search based derivation, or a combination of the calculation based derivation and the search based derivation. A first exemplary process where the calculation based derivation is used to determine the motion refinement, a second exemplary process where the search based derivation is used to determine the motion refinement, and a third exemplary process where the combination of the calculation based derivation and the search based derivation are used to determine the motion refinement are provided below.

In the first exemplary process where the calculation based derivation is applied, the video processor may determine, based on the intermediate motion vector, a current prediction of the video block. For example, the video processor may determine, based on the intermediate motion vector, a third reference block (Ref2) and a fourth reference block (Ref3) from first reference frame 802 and second reference frame 804, respectively. The video processor may determine the current prediction of the video block based on a weighted combination of the third reference block Ref2 and the fourth reference block Ref3 (e.g., the current prediction=w2*Ref2+w3*Ref3, where w2 and w3 denote weights for Ref2 and Ref3, respectively). In some examples, the third reference block Ref2 and the fourth reference block Ref3 may be an intermediate List 0 prediction and an intermediate List 1 prediction of the video block, respectively. The intermediate List 0 prediction and the intermediate List 1 prediction can be a List 0 prediction and a List 1 prediction of the video block based on the intermediate motion vector, respectively. In some implementations, w2 and w3 may be equal to w0 and w1, respectively. Alternatively, w2 and w3 may have values different from w0 and w1, respectively.

The video processor may determine an assumed motion model between the current prediction of the video block and the matching target, and derive the motion refinement for the intermediate motion vector based on the assumed motion model. For example, the assumed motion model can be used for motion refinement calculation as described below. In some implementations, before the bilateral matching based motion refinement process 706 is performed, the affine motion model of the video block may be a 4-parameter affine motion model (with 2 CPMVs) or a 6-parameter affine motion model (with 3 CPMVs). When the bilateral matching is utilized, the assumed motion model between the current prediction and the matching target may be linear or non-linear, which may be represented by a 2-parameter (linear), 4-parameter (non-linear), or 6-parameter (non-linear) motion model.

In some implementations, the assumed motion model may have the same number of parameters as the affine motion model of the video block. For example, the assumed motion model is a 6-parameter motion model, and the affine motion model is also a 6-parameter affine motion model. In another example, the assumed motion model is a 4-parameter motion model, and the affine motion model is also a 4-parameter affine motion model. Alternatively, the assumed motion model may have a different number of parameters from the affine motion model of the video block. For example, the affine motion model of the video block is a 6-parameter affine motion model, whereas the assumed motion model is a 2-parameter motion model or a 4-parameter motion model. In another example, the affine motion model of the video block is a 4-parameter affine motion model, whereas the assumed motion model is a 2-parameter motion model or a 6-parameter motion model.

For example, the affine motion model may be a 6-parameter affine motion model with 3 CPMVs at 3 control points {(v₀ₓ, v_{0y}), (v₁ₓ, v_{1y}), (v₂ₓ, v_{2y})}. Motion refinement for the intermediate motion vector (e.g., motion refinements for the 3 CPMVs) can be denoted as {(dv₀ₓ, dv_{0y}), (dv₁ₓ, dv₂ₓ, dv_{2y})}. A matching target luminance signal can be denoted as I(i, j), which is associated with the matching target. A prediction luminance signal can be denoted as I′ₖ(i, j), which is associated with the current prediction of the video block. The spatial gradient gₓ(i, j) and g_{y}(i, j) can be derived with a Sobel filter applied on the prediction signal I′ₖ(i, j) in the horizontal and vertical directions, respectively. A 6-parameter assumed motion model may be used to derive a motion refinement for each CPMV as follows:

dvₓ(x,y)=c*x+d*y+a

dv_{y}(x,y)=e*x+f*y+b (3)

In the above expression (3), (dvₓ(x, y), dv_{y}(x, y)) denote a delta motion refinement for the CPMV, a and b denote delta translation parameters, c and at denote delta zoom and rotation parameters for the horizontal direction, and e and f denote delta zoom and rotation parameters for the vertical direction.

Coordinates for the top-left, top-right, and bottom-left control points {(v₀ₓ, v_{0y}), (v₁ₓ, v_{1y}), (v₂ₓ, v_{2y})} are (0, 0), (w, 0), and (0, h), respectively, where w and h denote the width and height of the video block, respectively. Based on the above expression (3), the motion refinements for the 3 CPMVs at the three control points can be derived with their respective coordinates as the following expressions (4)-(6), respectively:

$$\{ \begin{matrix}{dv}_{0 x} = a \\ {dv}_{0 y} = b\end{matrix} \qquad ( 4 )$$

$$\{ \begin{matrix}{dv}_{1 x} = c * w + a \\ {dv}_{1 y} = e * w + b\end{matrix} \qquad ( 5 )$$

$$\{ \begin{matrix}{dv}_{2 x} = d * h + a \\ {dv}_{2 y} = f * h + b\end{matrix} \qquad ( 6 )$$

Based on the optical flow equation, the relationship between the change of luminance and the spatial gradient and temporal movement can be formulated as the following expression (7):

I′ₖ(i,j)−I(i,j)=gₓ(i,j)*dvₓ(i,j)+g_{y}(i,j)*dv_{y}(i,j) (7)

By substituting dvₓ(i, j) and dv_{y}(i, j) in the expression (7) with the expression (3), an expression (8) for the set of parameters (a, b, c, d, e, f) can be obtained as follows:

I′ₖ(i,j)−I(i,j)=(gₓ(i,j)*i)*c+(gₓ(i,j)*j)*d+(g_{y}(i,j)*i)*e+(g_{y}(i,j)*j)*f+gₓ(i,j)*a+g_{y}(i,j)*b (8)

Since all samples in the video block satisfy the expression (8), the set of parameters b, c, d, e, f) in (8) can be solved using a least square error method. Then, the motion refinements at the three control points {(v₀ₓ, v_{0y}), (v₁ₓ, v_{1y}), (v₂ₓ, v_{2y})} can be solved with the expressions (4)-(6), and can be rounded to a specific precision (e.g., 1/16 pel). Using the above calculation process as an iteration, the CPMVs at the three control points can be refined until they converge when the set of parameters (a, b, c, d, e, j) are all zeros, or a total number of iteration times meets a predetermined iteration upper limit.

In another example, the assumed motion model may be a 4-parameter motion model. For the motion refinement of each CPMV, the 4-parameter motion model may be represented using the following expression (9):

dvₓ(x,y)=c*x−d*y+a

dv_{y}(x,y)=d*x+c*y+b (9)

Coordinates for the top-left and top-right control points {(v₀ₓ, v_{0y}), (v₁ₓ, v_{1y})} can be (0, 0) and (w, 0), respectively. Based on the above expression (9), the delta motion refinements for the CPMVs at the two control points can be derived with their respective coordinates as the following expressions (10)-(11):

$$\{ \begin{matrix}{dv}_{0 x} = a \\ {dv}_{0 y} = b\end{matrix} \qquad ( 10 )$$

$$\{ \begin{matrix}{dv}_{1 x} = c * w + a \\ {dv}_{1 y} = d * w + b\end{matrix} \qquad ( 11 )$$

By substituting dvₓ(i, j) and dv_{y}(i, j) in the expression (7) with the expression (9), an expression (12) for the set of parameters (a, b, c, d) can be obtained as follows:

I′ₖ(i,j)−I(i,j)=(gₓ(i,j)*i+g_{y}(i,j)*j)*c+(−gₓ(i,j)*j+g_{y}(i,j)*i)*d+gₓ(i,j)*a+g_{y}(i,j)*b (12)

Similar to the above expression (8), the set of parameters (a, b, c, d) in (12) can be solved using a least square method by considering all samples within the video block.

In yet another example, the assumed motion model may be a 2-parameter motion model. For the motion refinement of each CPMV, c=d=e=f=0 (e.g., according to the above expression (3)). Then, the 2-parameter assumed motion model may be represented as:

$$\{ \begin{matrix}{dv}_{x} ( x , y ) = a \\ {dv}_{y} ( x , y ) = b\end{matrix} \qquad ( 13 )$$

As shown in the above expression (13), the motion refinement for any CPMV (e.g., the delta motion refinement at any control point) is the same. By substituting dvₓ(i, j) and dv_{y}(i, j) in the expression (7) with the expression (13), an expression (14) for the set of parameters (a, b) can be obtained as follows:

I′ₖ(i,j)−I(i,j)=gₓ(i,j)*a+g_{y}(i,j)*b (14)

Similar to the above expression (8), the set of parameters (a, b) in (14) can be solved using a least square method by considering all samples within the video block.

After obtaining the motion refinement through the above expression (3), (9), or (13), the video processor may update the intermediate motion vector using the derived motion refinement to obtain refined motion vector 714 based on an affine motion model of the video block. For example, each CPMV can be updated using the following expression:

vₓ^{new}=vₓ^{old}+dvₓ(x,y)

v_{y}^{new}=v_{y}^{old}+dv_{y}(x,y) (15)

In the above expression (15), vₓ^{old} and vₓ^{new} denote x-components of the CPMV before and after refinement in the horizontal direction, respectively, and v_{y}^{old} and v_{y}^{new} denote y-components of the CPMV before and after refinement in the vertical direction, respectively. Depending on the type of the affine motion model of the video block, a different number of CPMVs may need to be refined. For example, for a 4-parameter affine motion vector, two CPMVs may need to be updated; and for a 6-parameter affine motion model, three CPMVs may need to be updated. For each CPMV to be refined, the corresponding motion refinement may be derived using the corresponding coordinate (x, y) of the CPMV according to the above expression (3), (9), or (13).

For example, if the assumed motion model between the current prediction and the matching target is a 2-parameter motion model, the above expression (13) can be used to derive the motion refinement. That is, dvₓ(x, y)=a and dv_{y}(x, y)=b for each of the CPMVs. Furthermore, according to the above expression (15), if the affine motion model for the video block is a 6-parameter affine motion model, then three refined CPMVs at the three control points with coordinates (0, 0), (w, 0), and (0, h) for the 6-parameter affine motion model may be derived as follows:

$$\{ \begin{matrix}{v}_{0 x}^{new} = {v}_{0 x}^{old} + a \\ {v}_{0 y}^{new} = {v}_{0 y}^{old} + b\end{matrix} \qquad ( 16 )$$

$$\{ \begin{matrix}{v}_{1 x}^{new} = {v}_{1 x}^{old} + a \\ {v}_{1 y}^{new} = {v}_{1 y}^{old} + b\end{matrix} \qquad ( 17 )$$

$$\{ \begin{matrix}{v}_{2 x}^{new} = {v}_{2 x}^{old} + a \\ {v}_{2 y}^{new} = {v}_{2 y}^{old} + b\end{matrix} \qquad ( 18 )$$

In another example, if the assumed motion model between the current prediction and the matching target is a 4-parameter motion model, the above expression (9) can be used to derive the motion refinement. That is, dvₓ(x, y)=c*x−d*y+a and dv_{y}(x, y)=d*x+c*y+b for each of the CPMVs. Furthermore, according to the above expression (15), if the affine motion model for the video block is a 6-parameter affine motion model, then the three refined CPMVs at the three control points with coordinates (0, 0), (w, 0), and (0, h) for the 6-parameter affine motion model may be derived as follows:

$$\{ \begin{matrix}{v}_{0 x}^{new} = {v}_{0 x}^{old} + a \\ {v}_{0 y}^{new} = {v}_{0 y}^{old} + b\end{matrix} \qquad ( 19 )$$

$$\{ \begin{matrix}{v}_{1 x}^{new} = {v}_{1 x}^{old} + c * w + a \\ {v}_{1 y}^{new} = {v}_{1 y}^{old} + d * w + b\end{matrix} \qquad ( 20 )$$

$$\{ \begin{matrix}{v}_{2 x}^{new} = {v}_{2 x}^{old} - d * h + a \\ {v}_{2 y}^{new} = {v}_{2 y}^{old} + c * h + b\end{matrix} \qquad ( 21 )$$

In yet another example, if the assumed motion model between the current prediction and the matching target is a 6-parameter motion model, the above expression (3) can be used to derive the motion refinement. That is, dvₓ(x, y)=c*x+d*y+a and dv_{y}(x, y)=e*x+f*y+b for each of the CPMVs. Furthermore, according to the above expression (15), if the affine motion model for the video block is a 6-parameter affine motion model, then the three refined CPMVs at the three control points with coordinates (0, 0), (w, 0), and (0, h) for the 6-parameter affine motion model may be derived as follows:

$$\{ \begin{matrix}{v}_{0 x}^{new} = {v}_{0 x}^{old} + a \\ {v}_{0 y}^{new} = {v}_{0 y}^{old} + b\end{matrix} \qquad ( 22 )$$

$$\{ \begin{matrix}{v}_{1 x}^{new} = {v}_{1 x}^{old} + c * w + a \\ {v}_{1 y}^{new} = {v}_{1 y}^{old} + e * w + b\end{matrix} \qquad ( 23 )$$

$$\{ \begin{matrix}{v}_{2 x}^{new} = {v}_{2 x}^{old} + d * h + a \\ {v}_{2 y}^{new} = {v}_{2 y}^{old} + f * h + b\end{matrix} \qquad ( 24 )$$

In the second exemplary process where the search based derivation is applied to derive the motion refinement, the video processor may iteratively apply an incremental change (e.g., +1 or −1) to an intermediate motion vector of each control point in the horizontal and/or vertical direction. A corresponding change of the intermediate motion vector leading to a smaller matching cost may be kept and set as a new staring point for the next round of searching until a refined motion vector is obtained for each control point.

For example, the intermediate motion vector may be bi-directional and include a first motion vector for List 0 (e.g., referred to as an L0 motion vector) and a second motion vector for List 1 (e.g., referred to as an L1 motion vector). The progressive refinement of the L0 and L1 motion vectors may be separately performed by fixing the matching target and iteratively update the current prediction of the video block by using the updated L0 and/or L1 motion vectors. To reduce processing complexity, the refinement may be jointly performed for both the L0 and L1 motion vectors by using the same amount of refinement for the L0 and L1 motion vectors but with opposite directions. For example, the following expression (25) can be used to determine the updated L0 and L1 motion vectors:

v₀′=v₀+Δ, v₁′=v₁−k*Δ (25)

In the above expression (25), v₀ and v₁ denote the L0 and L1 motion vectors, respectively; v₀′ and v₁′ denote the updated L0 and L1 motion vectors, respectively; Δ and −Δ denote motion refinements applied for List 0 and List 1 with opposite directions, respectively; and k denotes a scaling factor which may be used to take the temporal distance into consideration. For example, k may be determined based on a ratio between a first temporal distance between the video frame and a first reference frame and a second temporal distance between the video frame and a second reference frame.

In some implementations, to iteratively update the intermediate motion vector of each control point, the video processor may firstly generate a first modified motion vector based on the intermediate motion vector and a first motion-vector change within a predetermined search range. For example, the first modified motion vector can be equal to the sum of the intermediate motion vector and the first motion-vector change, where the first motion-vector change can be an incremental change of the intermediate motion vector. The video processor may determine whether to assign the first motion-vector change as the motion refinement for the intermediate motion vector based on (a) a matching cost associated with the intermediate motion vector and (b) a current matching cost associated with the first modified motion vector.

For example, the video processor may determine a prediction of the video block based on the intermediate motion vector, and determine the matching cost associated with the intermediate motion vector based on the matching target and the prediction of the video block. The prediction of the video block can be a weighted combination of a List 0 prediction and a List 1 prediction of the video block based on the intermediate motion vector. The matching cost can be determined based on any matching cost function disclosed herein. Similarly, the video processor may also determine a current prediction of the video block based on the first modified motion vector, and determine the current matching cost associated with the first modified motion vector based on the matching target and the current prediction of the video block. The current prediction of the video block can be a weighted combination of a List 0 prediction and a List 1 prediction of the video block based on the first modified motion vector.

If the current matching cost associated with the first modified motion vector is less than the matching cost associated with the intermediate motion vector, the video processor may derive the motion refinement to be the first motion-vector change. As a result, the intermediate motion vector can be updated to be the first modified motion vector (e.g., the intermediate motion vector=the intermediate motion vector the first motion-vector change).

If current matching cost associated with the first modified motion vector is equal to or greater than the matching cost associated with the intermediate motion vector, the video processor may determine not to assign the first motion-vector change as the motion refinement. Instead, the video processor may generate a second modified motion vector based on the intermediate motion vector and a second motion-vector change within the predetermined search range (e.g., the second modified motion vector=the intermediate motion vector+the second motion-vector change). The video processor may determine whether to assign the second motion-vector change as the motion refinement based on the matching cost associated with the intermediate motion vector and another current matching cost associated with the second modified motion vector. If the other current matching cost associated with the second modified motion vector is less than the matching cost associated with the intermediate motion vector, the video processor may derive the motion refinement to be the second motion-vector change. Then, the intermediate motion vector can be updated to be the second modified motion vector. If the other current matching cost associated with the second modified motion vector is equal to or greater than the matching cost associated with the intermediate motion vector, the video processor may determine not to assign the second motion-vector change as the motion refinement.

By performing similar operations, the video processor may iteratively update the intermediate motion vector until a predetermined iteration-stop condition is satisfied. For example, the predetermined iteration-stop condition can be satisfied if available motion-vector changes within the predetermined search range are detected and processed or a total number of iterations satisfies a predetermined upper limit. The video processor may determine refined motion vector 714 for the video block to be the intermediate motion vector when the predetermined iteration-stop condition is satisfied.

In the third exemplary process where the combination of the calculation based derivation and the search based derivation are used to determine the motion refinement, the calculation based derivation may be used to quickly refine the intermediate motion vector at the beginning, and then the search based derivation may be followed to provide further refinement to obtain refined motion vector 714. Specifically, the video processor may determine the motion refinement for the intermediate motion vector through the calculation based derivation, and update the intermediate motion vector based on the motion refinement determined through the calculation based derivation. Then, the video processor may determine the motion refinement for the intermediate motion vector again through the search based derivation, and update the intermediate motion vector again based on the motion refinement determined through the search based derivation. As a result, refined motion vector 714 can be obtained for the video block.

After obtaining refined motion vector 714 for the video block, the video processor may perform a sub-block motion vector refinement process 716 to generate a motion vector 718 for each sub-block within the video block. Specifically, the video processor may refine a motion vector for each sub-block in the video block by using refined motion vector 714 of the video block as a starting point for the motion vector for the sub-block. The video processor may apply the affine motion model of the video block to refine the motion vector at the sub-block level. For example, the video processor may obtain a plurality of refined CPMVs for the video block through the bilateral matching based motion refinement process 706 described above, and then apply the above expression (1) or (2) to derive the motion vector for each sub-block using the refined CPMVs, depending on whether the affine motion model is a 4-parameter or 6-parameter affine motion model.

Consistent with the present disclosure, exemplary application conditions of the bilateral matching based motion refinement process 706 are provided herein. Specifically, for bilateral matching, a motion trajectory is assumed. However, when the motion trajectory is not linear, bilateral matching may not be used to derive reliable motion vectors. For example, bilateral matching may not work well with complicated motions like rotation, zoom, and warping. To derive a more reliable motion refinement, certain application conditions may be determined to restrict excessive use of bilateral matching.

In some implementations, only when the two reference frames are on two different sides of the current video frame (e.g., one reference frame is preceding to the current video frame, and the other reference frame is after the current video frame), the bilateral matching based motion refinement process 706 is applied. In some implementations, when the two reference frames are on the same side of the current video frame (e.g., the two reference frames are preceding to the current video frame, or the two reference frames are after the current video frame), and the temporal distance between the two reference frames meets a predetermined threshold (e.g., the temporal distance is smaller (or greater) than a predefined value), the bilateral matching based motion refinement process 706 can be applied. In some implementations, when the two reference frames are on the two different sides of the current video frame, and a first temporal distance between one of the reference frames and the current video frame is the same as a second temporal distance between the other of the reference frames and the current video frame, the bilateral matching based motion refinement process 706 can be applied.

Consistent with the present disclosure, the bilateral matching based motion refinement process 706 may be applied to affine motion at the block level, while sub-block motion vector refinement 716 may be applied to regular motion at the sub-block level. This is because at the sub-block level only regular motion is included, while at the block level affine motion (e.g., zoom in/out, rotation, or perspective motion, etc.) may also be included. For example, regular motion may include translation motion without zoom in/out, rotation, perspective motion, or other irregular motion. In some implementations, regular motion may be equivalent to a 2-parameter affine motion model.

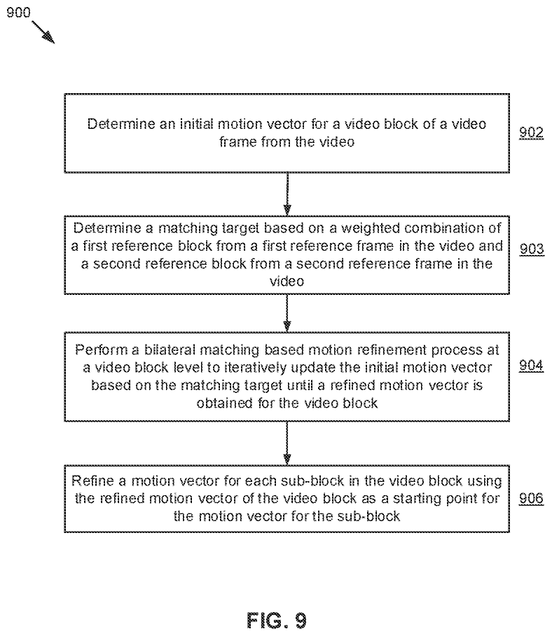

FIG. 9 is a flow chart of an exemplary method 900 for motion refinement in a video in accordance with some implementations of the present disclosure. Method 900 may be implemented by a video processor associated with video encoder 20 or video decoder 30, and may include steps 902-906 as described below. Some of the steps may be optional to perform the disclosure provided herein. Further, some of the steps may be performed simultaneously, or in a different order than shown in FIG. 9.

In step 902, the video processor may determine an initial motion vector for a video block of a video frame from the video.

In step 903, the video processor may determine a matching target based on a weighted combination of a first reference block from a first reference frame in the video and a second reference block from a second reference frame in the video. For example, the video processor may determine, based on the initial motion vector, the first reference block and the second reference block from the first reference frame and the second reference frame of the video, respectively. The video processor may determine a first weight for the first reference block and a second weight for the second reference block, respectively. The video processor may determine a weighted combination of the first reference block and the second reference block using the first and second weights. The video processor may determine the matching target based on the weighted combination of the first and second reference blocks.

In some implementations, the first and second weights may be identical to corresponding weights derived at an encoder side for normal weighted bi-predictions. For example, the normal weighted bi-predictions may have a weight for a List 0 prediction and a weight for a List 1 prediction. The first and second weights may be equal to the weight for the List 0 prediction and the weight for the List 1 prediction, respectively. Alternatively, the first and second weights may have predetermined values. For example, each of the first and second weights can be 0.5. In another example, the first weight can be 0, and the second weight can be 1. Or, the first weight can be 1, and the second weight can be 0.

In step 904, the video processor may perform a bilateral matching based motion refinement process at a video block level to iteratively update the initial motion vector based on the matching target until a refined motion vector is obtained for the video block. For example, the video processor may use the initial motion vector to initialize an intermediate motion vector, determine a motion refinement for the intermediate motion vector based on the matching target, and update the intermediate motion vector based on the motion refinement. The video processor may determine whether a predetermined iteration-stop condition is satisfied.

Responsive to the predetermined iteration-stop condition being satisfied, the video processor may determine the intermediate motion vector to be the refined motion vector. Responsive to the predetermined iteration-stop condition being not satisfied, the video processor may continue to iteratively determine the motion refinement for the intermediate motion vector and update the intermediate motion vector based on the motion refinement until the predetermined iteration-stop condition is satisfied.

In some implementations, the motion refinement can be determined through a calculation based derivation, a search based derivation, or a combination of the calculation based derivation and the search based derivation.

In step 906, the video processor may refine a motion vector for each sub-block in the video block using the refined motion vector of the video block as a starting point for the motion vector for the sub-block. The video processor may apply an affine motion model of the video block to refine the motion vector at a sub-block level.

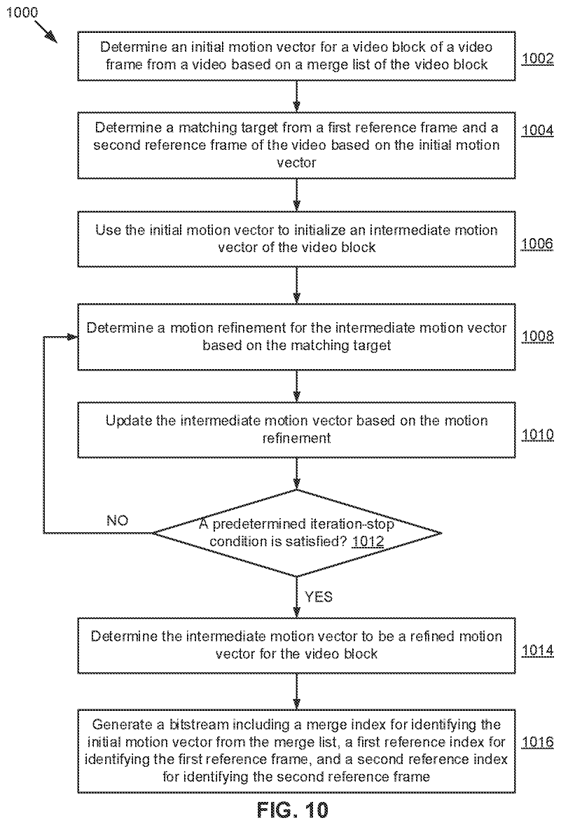

FIG. 10 is a flow chart of another exemplary method 1000 for motion refinement in a video, in accordance with some implementations of the present disclosure. Method 1000 may be implemented by a video processor associated with video encoder 20 or video decoder 30, and may include steps 1002-1016 as described below. Some of the steps may be optional to perform the disclosure provided herein. Further, some of the steps may be performed simultaneously, or in a different order than shown in FIG. 10.

In step 1002, the video processor may determine an initial motion vector for a video block of a video frame from the video based on a merge list of the video block.

In step 1004, the video processor may determine a matching target from a first reference frame and a second reference frame of the video based on the initial motion vector.

In step 1006, the video processor may use the initial motion vector to initialize an intermediate motion vector of the video block.

In step 1008, the video processor may determine a motion refinement for the intermediate motion vector based on the matching target.

In step 1010, the video processor may update the intermediate motion vector based on the motion refinement.

In step 1012, the video processor may determine whether a predetermined iteration-stop condition is satisfied. Responsive to the predetermined iteration-stop condition being satisfied, method 1000 may proceed to step 1014. Otherwise, method 1000 may return to step 1008.

In step 1014, the video processor may determine the intermediate motion vector to be a refined motion vector for the video block.

In step 1016, the video processor may generate a bitstream including a merge index for identifying the initial motion vector from the merge list, a first reference index for identifying the first reference frame, and a second reference index for identifying the second reference frame.

FIG. 11 shows a computing environment 1110 coupled with a user interface 1150, according to some implementations of the present disclosure. The computing environment 1110 can be part of a data processing server. The computing environment 1110 includes a processor 1120, a memory 1130, and an Input/Output (I/O) interface 1140.

The processor 1120 typically controls overall operations of the computing environment 1110, such as the operations associated with display, data acquisition, data communications, and image processing. The processor 1120 may include one or more processors to execute instructions to perform all or some of the steps in the above-described methods. Moreover, the processor 1120 may include one or more modules that facilitate the interaction between the processor 1120 and other components. The processor 1120 may be a Central Processing Unit (CPU), a microprocessor, a single chip machine, a Graphical Processing Unit (GPU), or the like.

The memory 1130 is configured to store various types of data to support the operation of the computing environment 1110. The memory 1130 may include predetermined software 1132. Examples of such data includes instructions for any applications or methods operated on the computing environment 1110, video datasets, image data, etc. The memory 1130 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 1140 provides an interface between the processor 1120 and peripheral interface modules, such as a keyboard, a click wheel, buttons, or the like. The buttons may include but are not limited to, a home button, a start scan button, and a stop scan button. The I/O interface 1140 can be coupled with an encoder and decoder.

In some implementations, there is also provided a non-transitory computer-readable storage medium comprising a plurality of programs, for example, in the memory 1130, executable by the processor 1120 in the computing environment 1110, for performing the above-described methods. Alternatively, the non-transitory computer-readable storage medium may have stored therein a bitstream or a data stream comprising encoded video information (for example, video information comprising one or more syntax elements) generated by an encoder (for example, video encoder 20 in FIG. 2) using, for example, the encoding method described above for use by a decoder (for example, video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In some implementations, there is also provided a computing device comprising one or more processors (for example, the processor 1120); and the non-transitory computer-readable storage medium or the memory 1130 having stored therein a plurality of programs executable by the one or more processors, wherein the one or more processors, upon execution of the plurality of programs, are configured to perform the above-described methods.

In some implementations, there is also provided a computer program product comprising a plurality of programs, for example, in the memory 1130, executable by the processor 1120 in the computing environment 1110, for performing the above-described methods. For example, the computer program product may include the non-transitory computer-readable storage medium.

In some implementations, the computing environment 1110 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A video coding method for motion refinement in a video, comprising:
determining, by one or more processors, an initial motion vector for a video block of a video frame from the video;
determining, by the one or more processors, a matching target based on a weighted combination of a first reference block from a first reference frame in the video and a second reference block from a second reference frame in the video;
performing, by the one or more processors, a bilateral matching based motion refinement process at a block level to iteratively update the initial motion vector based on the matching target until a refined motion vector is obtained for the video block; and
refining, by the one or more processors, a motion vector for each sub-block in the video block using the refined motion vector of the video block as a starting point for the motion vector for the sub-block, wherein refining the motion vector at a sub-block level applies an affine motion model of the video block.

2. The method of claim 1, wherein determining the matching target further comprises:
determining a first weight for the first reference block and a second weight for the second reference block, respectively; and
determining the weighted combination of the first reference block and the second reference block using the first weight and the second weight.

3. The method of claim 2, wherein:
the first weight and the second weight are identical to corresponding weights derived at an encoder side for weighted bi-predictions; or
the first weight and the second weight have predetermined values.

4. The method of claim 1, wherein performing the bilateral matching based motion refinement process further comprises:
using the initial motion vector to initialize an intermediate motion vector;
determining a motion refinement for the intermediate motion vector based on the matching target; and
updating the intermediate motion vector based on the motion refinement.

5. The method of claim 4, wherein performing the bilateral matching based motion refinement process further comprises:
determining whether a predetermined iteration-stop condition is satisfied;
responsive to the predetermined iteration-stop condition being satisfied, determining the intermediate motion vector to be the refined motion vector; or
responsive to the predetermined iteration-stop condition being not satisfied, continuing to iteratively determine the motion refinement for the intermediate motion vector and update the intermediate motion vector based on the motion refinement until the predetermined iteration-stop condition is satisfied.

6. The method of claim 5, wherein the motion refinement is determined through a calculation based derivation, a search based derivation, or a combination of the calculation based derivation and the search based derivation.

7. The method of claim 6, wherein the motion refinement is determined through the calculation based derivation, and wherein determining the motion refinement for the intermediate motion vector further comprises:
determining, based on the intermediate motion vector, a current prediction of the video block;
determining an assumed motion model between the current prediction and the matching target, wherein the assumed motion model is used for motion refinement calculation; and
calculating the motion refinement for the intermediate motion vector based on the assumed motion model.

8. The method of claim 7, wherein the predetermined iteration-stop condition is satisfied if the intermediate motion vector converges, or a total number of iterations meets a predetermined threshold.

9. The method of claim 7, wherein a total number of parameters of the assumed motion model is equal to a total number of parameters of the affine motion model.

10. The method of claim 7, wherein a total number of parameters of the assumed motion model is different from a total number of parameters of the affine motion model.

11. The method of claim 6, wherein the motion refinement is determined through the search based derivation, and wherein determining the motion refinement for the intermediate motion vector further comprises:
generating a first modified motion vector based on the intermediate motion vector and a first motion-vector change within a predetermined search range; and
determining whether to assign the first motion-vector change as the motion refinement based on a matching cost associated with the intermediate motion vector and a current matching cost associated with the first modified motion vector.

12. The method of claim 11, wherein the current matching cost associated with the first modified motion vector is determined by:
determining a current prediction of the video block based on the first modified motion vector; and
determining the current matching cost associated with the first modified motion vector based on the matching target and the current prediction of the video block.

13. The method of claim 11, further comprising:
responsive to the current matching cost associated with the first modified motion vector being less than the matching cost associated with the intermediate motion vector, deriving the motion refinement to be the first motion-vector change so that the intermediate motion vector is updated to be the first modified motion vector.

14. The method of claim 11, further comprising:
responsive to the current matching cost associated with the first modified motion vector being equal to or greater than the matching cost associated with the intermediate motion vector,
not assigning the first motion-vector change as the motion refinement;
generating a second modified motion vector based on the intermediate motion vector and a second motion-vector change within the predetermined search range; and
determining whether to assign the second motion-vector change as the motion refinement based on the matching cost associated with the intermediate motion vector and another current matching cost associated with the second modified motion vector.

15. The method of claim 11, wherein the predetermined iteration-stop condition is satisfied if available motion-vector changes within the predetermined search range are detected and processed or a total number of iterations satisfies a predetermined threshold.

16. The method of claim 6, wherein the motion refinement is determined through the combination of the calculation based derivation and the search based derivation, and wherein performing the bilateral matching based motion refinement process comprises:
determining the motion refinement for the intermediate motion vector through the calculation based derivation based on the matching target;
updating the intermediate motion vector based on the motion refinement determined through the calculation based derivation;
determining the motion refinement for the intermediate motion vector again through the search based derivation based on the matching target; and
updating the intermediate motion vector again based on the motion refinement determined through the search based derivation.

17. The method of claim 1, wherein the bilateral matching based motion refinement process is performed to obtain the refined motion vector when one of the following conditions is satisfied:
one of the first reference frame and the second reference frame is preceding to the video frame, and another of the first reference frame and the second reference frame is after the video frame; or
both the first reference frame and the second reference frame are preceding to or after the video frame, and a temporal distance between the first reference frame and the second reference frame meets a predetermined threshold.

18. A video coding apparatus for motion refinement in a video, comprising:
a memory configured to store at least one video frame of a video, the video frame comprising at least one video block; and
one or more processors configured to:
determine an initial motion vector for the video block;
determine a matching target based on a weighted combination of a first reference block from a first reference frame in the video and a second reference block from a second reference frame in the video;
perform a bilateral matching based motion refinement process at a block level to iteratively update the initial motion vector based on the matching target until a refined motion vector is obtained for the video block; and
refine a motion vector for each sub-block in the video block using the refined motion vector of the video block as a starting point for the motion vector for the sub-block, wherein the one or more processors apply an affine motion model of the video block to refine the motion vector at a sub-block level.

19. The video coding apparatus of claim 18, wherein to determine the matching target, the one or more processors are further configured to:
determine a first weight for the first reference block and a second weight for the second reference block, respectively; and
determine the weighted combination of the first reference block and the second reference block using the first weight and the second weight.

20. A non-transitory computer-readable storage medium storing a bitstream to be coded by a video coding method for motion refinement in a video, the method comprising:
determining an initial motion vector for a video block of a video frame from a video based on a merge list of the video block;
determining a matching target based on a weighted combination of a first reference block from a first reference frame in the video and a second reference block from a second reference frame in the video;
performing a bilateral matching based motion refinement process at a block level to iteratively update the initial motion vector based on the matching target until a refined motion vector is obtained for the video block;
refining a motion vector for each sub-block in the video block using the refined motion vector of the video block as a starting point for the motion vector for the sub-block, wherein refining the motion vector at a sub-block level applies an affine motion model of the video block; and
generating the bitstream comprising a merge index for identifying the initial motion vector from the merge list, a first reference index for identifying the first reference frame, and a second reference index for identifying the second reference frame.
